(19) United States
(12) Patent Application Publication
(10) Pub. No.: US 2019/0044413 A1
(43) Pub. Date: Feb. 7, 2019

(54) Vehicle Energy Harvesting System

(71) Applicant: Epitome Property Investments (PTY) LTD, Kempton Park (ZA)

(72) Inventor: Ramokotjo Clement Mokoenene, Kempton Park (ZA)

(73) Assignee: Epitome Property Investments (PTY) LTD, Kempton Park (ZA)

(21) Appl. No.: 15/764,834

(22) PCT Filed: Sep. 29, 2016
(86) PCT No.: PCT/IB2016/055830

§ 371 Date: Mar. 29, 2018

(30) Foreign Application Priority Data
Sep. 30, 2015 (ZA) 2015/07223

(51) Int. Cl. H02K 7/18; H02N 2/18; F01B 23/10; F16H 19/04; F16H 7/06

(52) U.S. Cl. CPC H02K 7/1861; H02K 7/1823; F16H 7/06; F01B 23/10; F16H 19/043; H02N 2/18

(57) ABSTRACT

An energy harvesting system (100) for harvesting energy from vehicles travelling on a road (102). The system (100) includes a plurality of flexible hoses (104) which are embedded in a road overlay (106). Each hose (104) holds a hydraulic fluid, e.g. water, such that, when a vehicle wheel (108) passes over the hose (104), the fluid is displaced. The system (100) further comprises a plurality of double-acting hydraulic fluid cylinders (109) which are in fluid flow communication with the fluid in the hoses (104) and are configured to convert pressure applied to the fluid into rotary motion which drives an electrical generator. One hose is connected to each end of the cylinder (109) to drive it in opposite directions to induce linear reciprocating motion which is converted to rotary motion by way of a mechanical drivetrain. Due to the double action, it drives at least two drive shafts simultaneously.

### FIELD OF INVENTION

The invention is in the field of power generation, and relates in particular to a system for harvesting energy from vehicles travelling on roads and converting the harvested energy into electrical power.

### BACKGROUND OF INVENTION

Current renewable energy efforts are based on the use of traditional systems for harvesting energy from solar rays, wind, tidal flow, biomass and recycling of waste products. These systems, although effective in contributing to power in our electricity grids, often do not come without problems. Very often these traditional systems are made from complicated technology and some of them are effective only when certain atmospheric parameters are met or conditions are suitable.

Roads are generally viewed as dead and passive infrastructure. In practice, very little attention has been given to harvesting massive amounts of energy that is transferred by vehicles or automobiles onto or into roads. The Applicant believes that these infrastructures could be transformed into a source of renewable energy.

The Applicant has devised a system which can harvest energy from road surfaces, and possibly supplement or be a substitute for traditional coal-fired energy transformation or power generation systems.

### SUMMARY OF INVENTION

In accordance with the invention, there is provided an energy harvesting system for harvesting energy from vehicles travelling on a road, the system including:
a plurality of tubular members embedded within a road surface or within an overlay placed on a road surface, the tubular members being arranged transverse to a direction of travel on the road, each tubular member including an energy transfer fluid which is contained within the tubular member such that, when a vehicle wheel passes over the tubular member, it is subjected to compression or a compressive load which serves to displace the energy transfer fluid; and
an energy converting means which is in fluid flow communication with the fluid in the tubular members and is configured to convert pressure applied to the energy transfer fluid into electrical power, wherein the energy converting means includes:
   at least one double-acting fluid cylinder which is in fluid flow communication with two tubular members such that the energy transfer fluid within the respective tubular members is configured to drive the fluid cylinder in opposite directions to induce reciprocating motion of the cylinder; and
   a drivetrain which drivingly connects the fluid cylinder to an electrical generator which is configured to convert rotary motion into electrical energy.

The drivetrain may include a drive shaft to which the electrical generator is connected or connectable. The drivetrain may include at least one pair of drive shafts. Each driveshaft may be configured for rotation about a separate drive axis. At least one electrical generator may be connected or connectable to each shaft.

Each double-acting cylinder may have an arm protruding from each end of the cylinder which is drivingly connected b the drivetrain. The drivetrain may include a rack which is connected to the arm of the cylinder. The drivetrain may further include a drive pinion which is mounted to the drive shaft. The rack may mesh with the pinion. The drive pinion may include a freewheeling mechanism which permits the pinion to drive the drive shaft in one direction and freewheel relative to the shaft in the opposite direction. A rack and pinion arrangement as described above may connect each arm of the cylinder to one of the drive shafts.

The system may include a plurality of fluid cylinders. Corresponding rack and pinion arrangements connected to the cylinders may be drivingly connected to the pair of drive shafts.

In an alternative embodiment of the system, the double-acting cylinder may have an arm protruding from each end of the cylinder which is drivingly connected to a chain and sprocket arrangement. At least one sprocket of the arrangement may be mounted to the drive shaft. The sprocket may include a freewheeling mechanism which permits the sprocket to drive the drive shaft in one direction and freewheel relative to the shaft in the opposite direction. The chain and sprocket arrangement may be drivingly connected to at least one pair of drive shafts configured to rotate about separate axes.

The fluid cylinder may be a hydraulic cylinder. Alternatively, the fluid cylinder may be a pneumatic cylinder. The electrical generator may be an electrical motor. The generator may also be a turbine.

The tubular members may be obliquely angled with respect to a line perpendicular to the direction of travel across the road.

The tubular members may be parallel to one another and longitudinally spaced apart with respect to the road surface. The tubular members may extend at least partially across a width of the road from one side of the road.

The invention extends to a method of harvesting energy from a road, the method including:
embedding a plurality of tubular members, each having an energy transfer fluid contained within it, within the road or within an overlay placed over the road such that the tubular members are arranged transverse to a direction of travel on the road;
subjecting the tubular members to a pressure force exerted by a vehicle wheel passing over the road such that the energy transfer fluid within the tubular member is pressurised or displaced by the pressure force; and
converting pressure applied to the energy transfer fluid into electrical power using at least one double-acting fluid cylinder which is in fluid flow communication with the energy transfer fluid in the tubular members such that the energy transfer fluid within the tubular members is configured to drive the fluid cylinder in opposite directions to induce reciprocating motion of the cylinder and which is drivingly connected to a drive shaft of an electrical generator by way of a mechanical drivetrain.

The members may extend across more than one lane of the road.

The elongate tubular members may be in the form of flexible hoses, pipes or tubes. The energy transfer fluid may be a hydraulic fluid, for example, water or oil.

The road overlay may have substantially the same surface properties of an existing conventional tar road surface, advantageously for purposes of not altering driving conditions of the road.

The vehicle energy harvesting system may include control means for controlling the amount of fluid displaced toward a second end of the elongate tubular member, such controlled amount of fluid being dischargeable from the elongate tubular member, for example, as a jet stream of fluid. The controlling means may for example be a valve, such as, but not limited to, a butterfly valve or ball valve.

The vehicle energy harvesting system may include replenishing means for supplying a predetermined amount of fluid into each of the elongate tubular members upon ejection or discharge of fluid from a portion of the elongate tubular member in communication with the energy converting means or transducer, in order to replenish fluid in the tubular member. The replenishing means may be a pump, such as a variable speed pump, configured to pump a predetermined amount of fluid ejected from the elongate tubular member back into the member. The replenishing means may include at least one reservoir or supply tank with fluid. A control valve, for example, may operatively control the amount of fluid pumped back into the elongate tubular member. The pump may be connected to a water or fluid collection storage tank, for collecting fluid ejected from the elongate tubular member. A supply tank may be provided for supplying fresh fluid to the tubular members to compensate for fluid losses in the system.

### BRIEF DESCRIPTION OF DRAWINGS

The invention will now be further described, by way of example, with reference to the accompanying diagrammatic drawings.

In the drawings:

FIG. 1 shows a partial cross-sectional view through an energy harvesting system in accordance with the invention for harvesting energy from at least a segment of a road;

FIG. 2 shows a plan view of the system of FIG. 1;

FIG. 3 shows a three-dimensional view of the energy harvesting system of FIG. 1;

FIG. 4 shows a side elevation of part of a second embodiment of the energy harvesting system in accordance with the invention in which the drivetrain includes a chain and sprocket arrangement;

FIG. 5 shows a cross-sectional view through a road overlay comprising two interlocked segments; and

FIG. 6 shows a three-dimensional illustration of an alternative embodiment of a road overlay.

### DETAILED DESCRIPTION OF EXAMPLE EMBODIMENT

The following description of the invention is provided as an enabling teaching of the invention. Those skilled in the relevant art will recognise that many changes can be made to the embodiment described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof.

For general understanding of the present invention, reference is made to the accompanying figures. In the figures, like reference numerals have been used throughout to designate similar elements.

As used herein, singular forms “a”, “an” and “the” are intended to include the plural forms as well, unless the text clearly indicates otherwise.

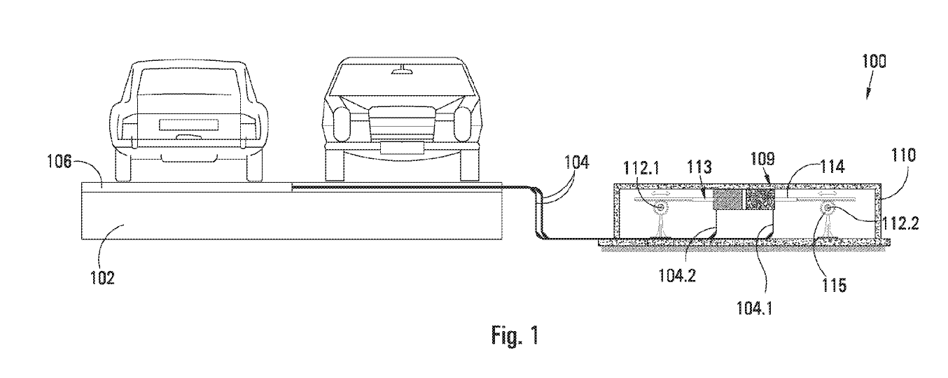

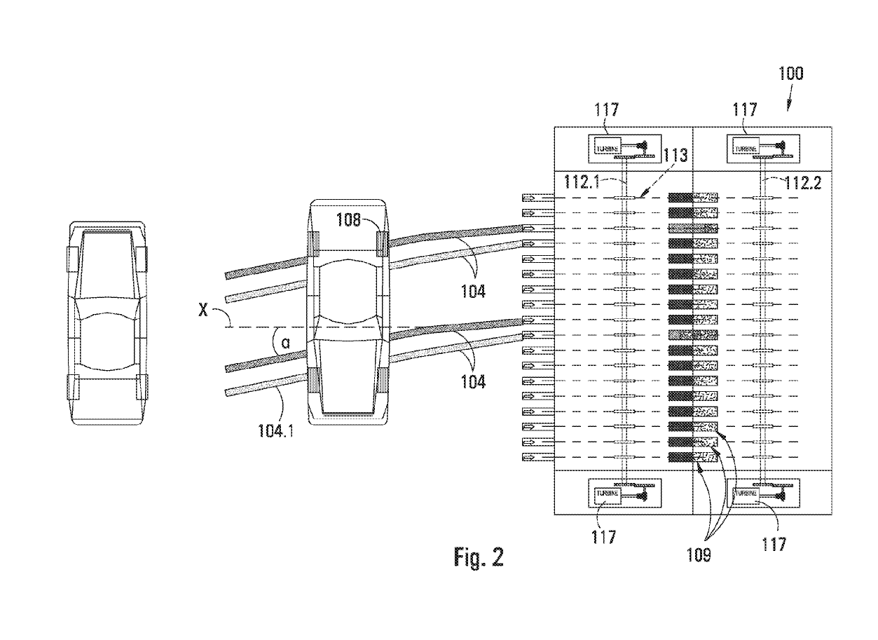

As can be seen in FIG. 1 of the drawings, reference numeral 100 designates generally a vehicle energy harvesting system in accordance with the invention for harvesting energy from vehicles travelling on a road 102. The system 100 includes a plurality of tubular members in the form of flexible hoses or pipes 104 which are embedded within a road surface or within a composite surface overlay 106 comprising bitumen and/or rubber which is placed over the road surface 102. As can be seen in FIG. 2, the pipes 104 are arranged transverse to a direction of travel on the road 102 and at an oblique angle (α) relative to a line X perpendicular to the direction of travel. The pipes may also be arranged perpendicular to the direction of travel. Each pipe or hose 104 holds a hydraulic energy transfer fluid, for example water or an oil, which is contained within the tubular member such that, when a vehicle wheel 108 passes over the hose 104, it is subjected to compression or a compressive load which serves to displace the energy transfer fluid. The system 100 further comprises energy converting means which is in fluid flow communication with the fluid in the hoses 104 and is configured to convert pressure applied to the energy transfer fluid into electrical power. The energy converting means includes a plurality of double-acting hydraulic fluid cylinders 109 which are arranged side-by-side in a chamber 110 next to the road 102. Each cylinder 109 is in fluid flow communication with two tubular members or hoses 104, one connected to each end of the cylinder 109, such that the energy transfer fluid within the respective hoses 104 is configured to drive the fluid cylinder 109 in opposite directions to induce linear reciprocating motion of the cylinder 109 (see FIGS. 1, 2 and 3).

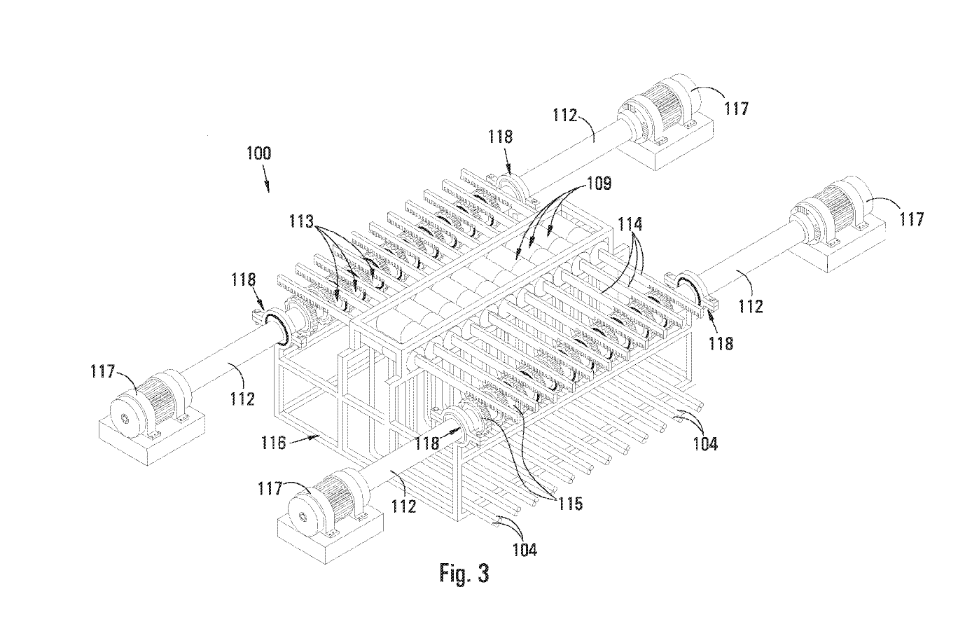

The energy converting means further includes a pair of drive shafts 112, one each side of the series of cylinders 109. The drive shafts 112 are configured to rotate about separate, parallel drive axes. A drivetrain 113, which, in the example embodiment illustrated in FIGS. 1 to 3, is in the form of a rack and pinion arrangement, drivingly connects each end of each fluid cylinder 109 to one of drive shafts 112. Each cylinder 109 has an arm protruding from each end of the cylinder 109 which is connected to the rack 114. The arm and rack may also be integrated into a unitary piece. A drive pinion 115 of the rack and pinion arrangement is mounted to the drive shaft 112. A rack 114 meshes with each drive pinion 115. The drive pinion 115 includes a freewheeling mechanism which permits the pinion 115 to drive the drive shaft 112 in one direction and to freewheel relative to the shaft 112 in the opposite direction. A frame 116 supports the cylinders 109 and drive shafts 112 as shown in FIG. 3. Bearing arrangements 118 isolate rotation of the shafts 112 from the frame 116. An electrical generator 117 is coupled to each end of each drive shaft 112 to convert rotation of the shaft 112, induced by the reciprocating cylinders 109, into electrical energy.

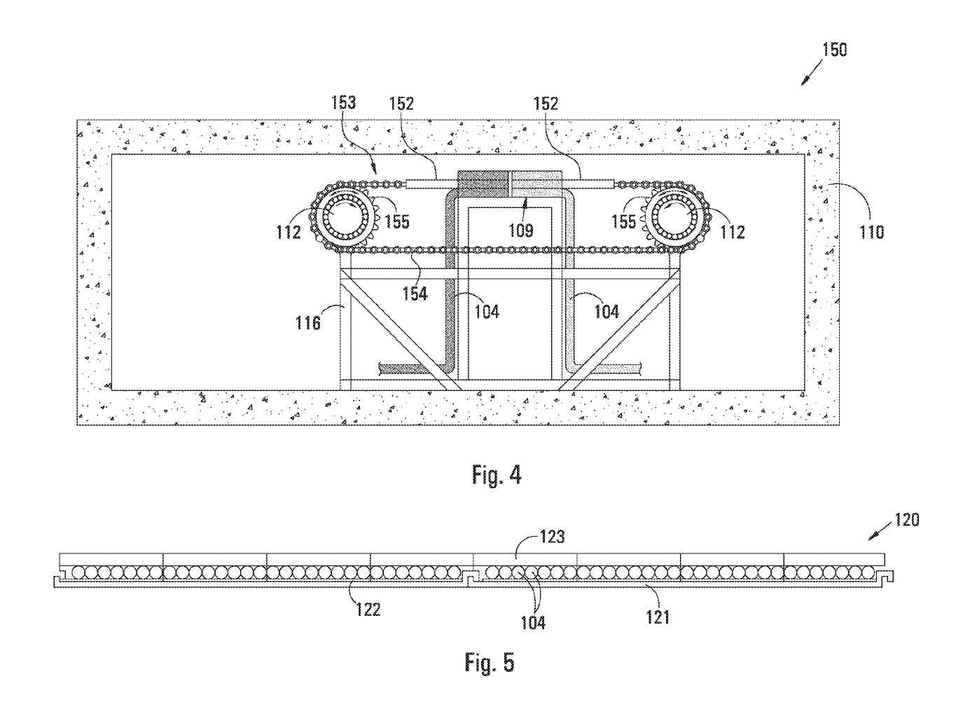

An alternative embodiment of the energy harvesting system is illustrated in FIG. 4 and designated by numeral 150. Like reference numerals have been used to refer to similar features of the system 150. As described above, the system 150 also includes a plurality of hoses 104, containing energy transfer fluid (water or oil), which are embedded in the road or in a road overlay and are connected in fluid flow communication to double-acting hydraulic fluid cylinders 109 arranged side-by-side within a concrete chamber 110. The cylinders 109 and the cooperating pair of drive shafts 112 are supported by a frame 116. This second embodiment has an alternative drivetrain 153 in the form of a chain and sprocket arrangement. Other examples of possible drivetrains are a belt and pulley drive or a meshed gear drive or gearbox (not shown).

As before, each double-acting cylinder 109 has an arm 152 protruding from each end of the cylinder 109 which is drivingly connected to the chain and sprocket arrangement. A chain 154 is connected to both arms 152 in continuous fashion. A sprocket 155 of the arrangement is mounted to each drive shaft 112 and includes a freewheeling mechanism which permits the sprocket to drive the drive shaft 112 in one direction and freewheel relative to the shaft in the opposite direction. The drive shafts 112 are connected to electrical generators, as before.

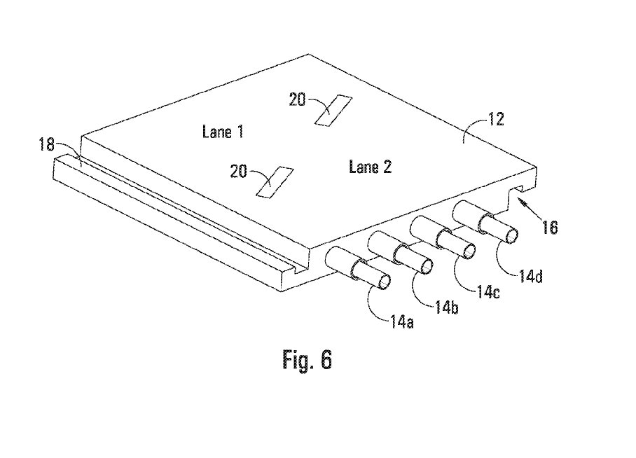

In order to harvest energy from roads, the hoses 104 may be embedded in a road during construction of the road. Retrospectively, however, a road overlay 12, 120 is provided which is placed over an existing road surface in segments. Referring now to FIG. 6, an arrangement of elongate tubular members or hoses 14a, 14b, 14c, 14d are embedded in the overlay 12 and extend therefrom. The overlay 12 has a front side 16 and rear side 18, respectively defining complementary male and female engaging formations configured to interconnect or engage with adjacent road overlays (not shown). The formations are in the form of oppositely orientated protruding lugs which extend from side to side. The lugs are configured removably to interlock by hooking onto one another. A top/upper surface of the overlay 12 may resemble a normal road surface having lanes (Lane 1 and Lane 2) demarcated by longitudinally aligned, spaced apart lines 20. The tubular members 14 extend transversely across a direction of travel, through the overlay 12 and are spaced apart along the direction of travel. In a preferred embodiment, the members 14 are obliquely slanted with respect to a line perpendicular to the direction of travel. The tubular members 14 are embedded in elongate cavities or passages formed in the overlay 12. Ends of the tubular members protrude from the overlay 12 and are connected to the cylinders. It is to be appreciated that, despite this not being illustrated in the drawings, a conventional road surface may be constructed with elongate tubular members embedded therein such that the members extend transversely across the direction of travel over or partially through the road surface. The scope of the invention therefore extends to such a configuration.

An alternative construction of a road overlay 120 has been illustrated in FIG. 5. The overlay 120 comprises a base layer 121 with interlocking ends on top of which a rubber membrane 122 is placed. The hoses 104 are arranged on top of the membrane 122. Finally an upper layer 123 is placed over the hoses 104. Adjacent segments of the overlay 120 are configured to interlock as shown in FIG. 5. Due to the angle of the hoses 104 with respect to the direction of travel, the wheels 108 of the vehicle do not strike the hoses 104 simultaneously. This is to eliminate possible destructive interference of the fluid in the hoses 104. Referring back to FIGS. 1 and 2, in use, the weight of a passing vehicle is transferred through the wheel 108 of the vehicle to a portion of the overlay 12, 120 which is in contact with and which coincides with the hose 104.1. Under the weight of the vehicle, the hose 104.1 is compressed and fluid contained therein is displaced under pressure to the fluid cylinder 109 and forces a piston of the cylinder 109 toward one end (to the left) which accordingly displaces the rack 114 or the chain 154 which rotates the shaft 112.1 in an anti-clockwise direction by way of the pinion 115 or sprocket 155. When the adjacent hose 104.2 (see FIG. 1) connected to the same cylinder 109 is compressed by the same wheel, the fluid in the hose 104.2 is forced into the opposite end of the double-acting cylinder 109 in order to force the piston in the opposite direction (to the right). Due to the free-wheeling mechanism of the pinion 115 or sprocket 155, the shaft 112.1 continues to rotate freely with respect to the drivetrain 113 in an anticlockwise direction whilst the pinion 115 rotates in the opposite direction. However, the opposite drive shaft 112.2 is now being driven in a clockwise direction by the pinion 115 or sprocket 155. As the piston reciprocates, the drive shafts 112.1, 112.2 are driven every alternate stroke in a direction which depends on the configuration of the freewheeling mechanism. The resultant rotary motion is used to generate electricity using the generator 117 which is fed back into the grid. The electricity may be stored on site using capacitors and/or batteries and/or be distributed to an electricity power grid line. Two tubular members or hoses 104 are therefore provided per cylinder 109 to harvest energy. In addition, the system could also be used to convert pressure from vehicles into flow within the tubular members and harvested using an inline turbine. In this case, to prevent the reverse flow that will cause major energy losses, a non-return valve will be installed downstream of the turbine.

The Applicant also envisages the creation or imitation of traffic flow across the harvesting system 100, 150, either manually or automatically, should the volume of traffic drop below that required to produce the contracted electricity output. Traffic lanes may take a form similar to a race track with single or multiple lanes with vehicles driving in a loop or it could include vehicles driving back and forth on a specially design stretch of road. The vehicles could be pulled/pushed back and forth by a hydraulically operated machine or some other power source to replicate the action of vehicles travelling on the road.

The Applicant believes that the vehicle energy harvesting system 100, 150 as described above will facilitate recycling of wasted energy which is ordinarily transferred to our roads. The system 100 can be retrofitted to existing roads using the road overlay 12, 120 or retrofitted directly into the existing road layer(s) to generate electricity from existing road surfaces or could be installed when new roads are built. It can be installed to span the entire length of a road thus maximising energy harvesting. The overlay 120 is designed to resemble and not significantly alter driving conditions. In order to further limit destructive interference of the energy transfer fluid, the tubular members may be arranged at an angle relative to the direction of travel, i.e. not 90 degrees. It is envisaged that the road overlay segments will be prefabricated and installed incrementally on a road in order to limit possible disruption to traffic flow. The overlay can be removed at any stage to return the road to its original condition. Furthermore, replacement or maintenance performed on the tubes can be conducted without disrupting traffic flow as the tubes are easily removable/replaceable. The double-acting fluid cylinders 109 increase efficiency of the conversion system 100 by making it to possible to drive two or more shafts 112 simultaneously.

1.-15. (canceled)

16. An energy harvesting system for harvesting energy from vehicles travelling on a road, the system including:
a plurality of tubular members embedded within a road surface or within an overlay placed on a road surface, the tubular members being arranged transverse to a direction of travel on the road, each tubular member including an energy transfer fluid which is contained within the tubular member such that, when a vehicle wheel passes over the tubular member, it is subjected to compression or a compressive load which serves to displace the energy transfer fluid; and
an energy converting means which is in fluid flow communication with the fluid in the tubular members and is configured to convert pressure applied to the energy transfer fluid into electrical power, wherein the energy converting means includes:
at least one double-acting fluid cylinder which is in fluid flow communication with two tubular members such that the energy transfer fluid within the respective tubular members is configured to drive the fluid cylinder in opposite directions to induce reciprocating motion of the cylinder; and
a drivetrain which drivingly connects the fluid cylinder to an electrical generator which is configured to convert rotary motion into electrical energy, wherein the drivetrain includes at least a pair of drive shafts, each configured for rotation about a separate drive axis, an electrical generator being connected or connectable to each shaft.

17. An energy harvesting system as claimed in claim 16, wherein the double-acting cylinder has an arm protruding from each end of the cylinder which is drivingly connected to the drivetrain.

18. An energy harvesting system as claimed in claim 17, wherein the drivetrain includes a rack which is connected to the arm of the cylinder and a drive pinion which is mounted to the drive shaft, the drive pinion including a freewheeling mechanism which permits the pinion to drive the drive shaft in one direction and freewheel relative to the shaft in the opposite direction.

19. An energy harvesting system as claimed in claim 18, wherein a rack and pinion arrangement as claimed in claim 3 connects each arm of the cylinder to one of the drive shafts.

20. An energy harvesting system as claimed in claim 19, which includes a plurality of fluid cylinders and corresponding rack and pinion arrangements which are drivingly connected to the pair of drive shafts.

21. An energy harvesting system as claimed in claim 16, wherein the double-acting cylinder has an arm protruding from each end of the cylinder which is drivingly connected to a chain and sprocket arrangement, at least one sprocket of the arrangement being mounted to the drive shaft and includes a freewheeling mechanism which permits the sprocket to drive the drive shaft in one direction and freewheel relative to the shaft in the opposite direction.

22. An energy harvesting system as claimed in claim 21, wherein the chain and sprocket arrangement is drivingly connected to the pair of drive shafts configured to rotate about separate axes.

23. An energy harvesting system as claimed in claim 16, wherein the fluid cylinder is a hydraulic cylinder.

24. An energy harvesting system as claimed in claim 16, wherein the fluid cylinder is a pneumatic cylinder.

25. An energy harvesting system as claimed in claim 16, wherein the electrical generator is an electrical motor.

26. An energy harvesting system as claimed in claim 16, wherein the tubular members are obliquely angled with respect to a line perpendicular to the direction of travel across the road.

27. An energy harvesting system as claimed in claim 26, wherein the tubular members are parallel to one another and longitudinally spaced apart with respect to the road surface, the tubular members extending at least partially across a width of the road from one side of the road.

28. A method of harvesting energy from a road, the method including:
embedding a plurality of tubular members, each having an energy transfer fluid contained within it, within the road or within an overlay placed over the road such that the tubular members are arranged transverse to a direction of travel on the road;
subjecting the tubular members to a pressure force exerted by a vehicle wheel passing over the road such that the energy transfer fluid within the tubular member is pressurised or displaced by the pressure force; and
converting pressure applied to the energy transfer fluid into electrical power using at least one double-acting fluid cylinder which is in fluid flow communication with the energy transfer fluid in the tubular members such that the energy transfer fluid within the tubular members is configured to drive the fluid cylinder in opposite directions to induce reciprocating motion of the cylinder and which is drivingly connected, by way of a mechanical drivetrain, to a pair of drive shafts, each of which is connected to an electrical generator.
